(19) United States
(12) Patent Application Publication
(10) Pub. No.: US 2019/0171309 A1
(43) Pub. Date: Jun. 6, 2019

(54) THEMED ELECTRONIC TABLET WITH FRONT AND BACK SCREEN

(71) Applicant: Sandra Delory Mims, Selma, AL (US)

(72) Inventor: Sandra Delory Mims, Selma, AL (US)

(21) Appl. No.: 16/210,169

(22) Filed: Dec. 5, 2018

Related U.S. Application Data
(60) Provisional application No. 62/594,759, filed on Dec. 5, 2017.

(51) Int. Cl. G06F 3/041

(52) U.S. Cl. CPC G06F 3/041

(57) ABSTRACT

An electronic tablet includes a housing having a front surface having a front periphery and a rear surface having a rear periphery. The front periphery is an outline of a design and the rear periphery is an outline of a mirror image of the design. The tablet further includes a computing system coupled to and disposed within the housing. The computing system includes a processor, a memory, a communications interface, and a user interface including a first touch screen interface disposed on the front surface, and a second touch screen interface disposed on the rear surface. A power button may be coupled to the housing and electrically connected to the computing system.

### CROSS-REFERENCE TO RELATED APPLICATION

This application claims the benefit of priority of U.S. provisional application No. 62/594,759, filed Dec. 5, 2017, the contents of which are herein incorporated by reference.

### BACKGROUND OF THE INVENTION

The present invention relates to electronic tablets and, more particularly, to a themed electronic tablet with a front and back screen.

Alzheimer's and dementia patients have an inability to keep past and present memories. Patient's further deal with ongoing confusion, a lack of understanding of who their families and friends are, forgetfulness, loneliness, and lack enjoyment due to these ailments. Current tablets are overly complicated to use to perform simple tasks for those with Alzheimer's and dementia.

As can be seen, there is a need for an easy to use themed electronic tablet with a front and back screen for Alzheimer's and dementia patients.

### SUMMARY OF THE INVENTION

In one aspect of the present invention, an electronic tablet comprises: a housing comprising a front surface having a front periphery and a rear surface having a rear periphery, wherein the front periphery is an outline of a design, and the rear periphery is an outline of a mirror image of the design; and a computing system coupled to and disposed within the housing, the computing system comprising: a processor; a memory a communications interface; and a user interface comprising at least a first touch screen interface disposed on the front surface, and a second touch screen interface disposed on the rear surface.

These and other features, aspects and advantages of the present invention will become better understood with reference to the following drawings, description and claims.

### BRIEF DESCRIPTION OF THE DRAWINGS

FIG. 1 is a front perspective view of an embodiment of the present invention;

FIG. 2 is a rear perspective view of an embodiment of the present invention;

FIG. 3 is a front view of an embodiment of the present invention;

FIG. 4 is a front view of an embodiment of the present invention;

FIG. 5 is a front view of an embodiment of the present invention;

FIG. 6 is a front view of an embodiment of the present invention;

FIG. 7 is a front view of an embodiment of the present invention;

FIG. 8 is a front view of an embodiment of the present invention;

FIG. 9 is a front view of an embodiment of the present invention;

FIG. 10 is a front view of an embodiment of the present invention;

FIG. 11 is a front view of an embodiment of the present invention;

FIG. 12 is a front view of an embodiment of the present invention;

FIG. 13 is a front view of an embodiment of the present invention;

FIG. 14 is a front view of an embodiment of the present invention; and

FIG. 15 is a front view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a collection of tablet devices that have different shapes and include a front and back touchscreen. The tablets may be in the shape of sports equipment, animals, accessories, and the like. The tablets may further include a variety of different colors for the user to choose.

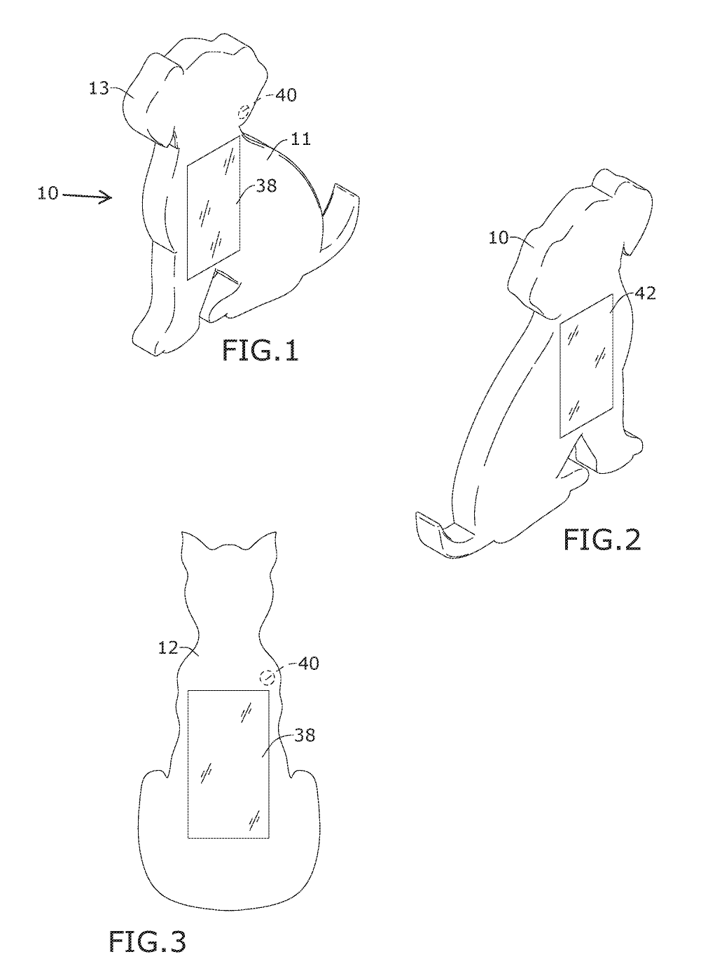

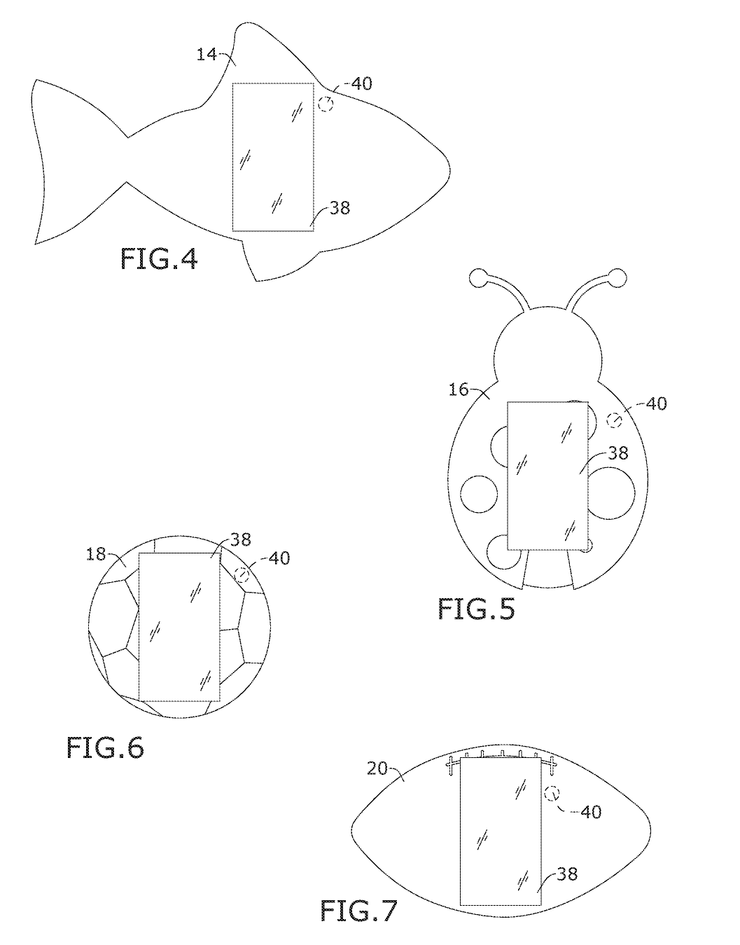

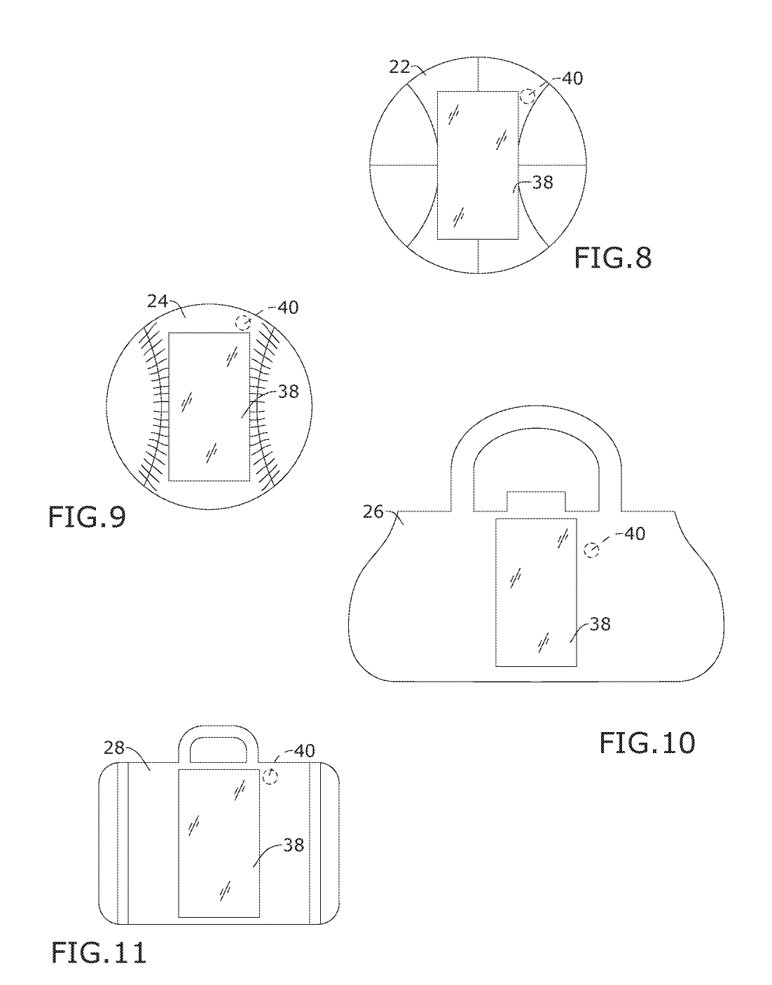

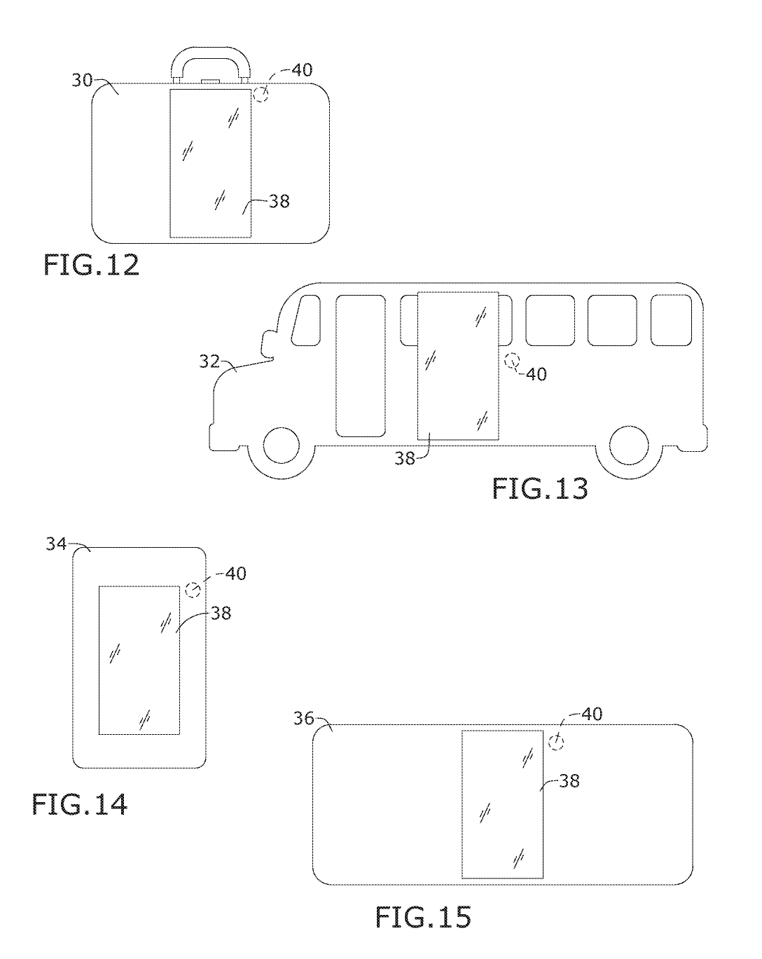

Referring to FIGS. 1 through 15, the present invention includes an electronic tablet 10. The tablet 10 includes a housing 13 having a front surface having a front periphery and a rear surface having a rear periphery. The front periphery is an outline of a design 11 and the rear periphery is an outline of a mirror image of the design 11. The tablet 10 further includes a computing system coupled to and disposed within the housing 13. The computing system includes a processor, a memory, a communications interface, and a user interface including a first touch screen interface 38 disposed on the front surface, and a second touch screen interface 42 disposed on the rear surface. The touch screen interfaces 38, 42 may be disposed along parallel planes. A power button 40 may be coupled to the housing and electrically connected to the computing system.

The design of the tablet 10 may be a 3-dimensional shape. For example, the outer shape of the housing 13 may be of sports equipment, animals, accessories, and the like. As illustrated in the Figures, the design is an outer shape of a basketball 22, a soccer ball 18, a football 20, a baseball 24, a cat 12, a dog 15, a fish 14, a purse 26, a can of corn 34, a can of tuna 36, a ladybug 16, a school bus 32, a briefcase 30, and a lunchbox 28.

As mentioned above, the electronic tablet 10 of the present invention includes a computing system. The computing system is at least the processor and the memory. The computing system may execute on any suitable operating system such as IBM's zSeries/Operating System (z/OS), MS-DOS, PC-DOS, MAC-iOS, WINDOWS, UNIX, OpenVMS, ANDROID, an operating system based on LINUX, or any other appropriate operating system, including future operating systems.

In particular embodiments, the computing system includes a processor, memory, a user interface, and a communication interface. In particular embodiments, the processor includes hardware for executing instructions, such as those making up a computer program. The memory includes main memory for storing instructions such as computer program(s) for the processor to execute, or data for processor to operate on. The memory may include an HDD, a floppy disk drive, flash memory, an optical disc, a magneto-optical disc, magnetic tape, a Universal Serial Bus (USB) drive, a solid-state drive (SSD), or a combination of two or more of these. The memory may include removable or non-removable (or fixed) media, where appropriate. The memory may be internal or external to computing system, where appropriate. In particular embodiments, the memory is non-volatile, solid-state memory.

The user interface includes hardware and software for providing one or more interfaces for user communication with the computing system. As mentioned above, the user interface includes a front touchscreen 38 and a rear touchscreen 42, each having display interconnect. The user interface may also include a keyboard, keypad, microphone, monitor, mouse, printer, scanner, speaker, still camera, stylus, trackball, video camera, another user interface or a combination of two or more of these.

The communication interface includes hardware, software, or both providing one or more interfaces for communication (e.g., packet-based communication) between the computing system and one or more other computing systems or one or more networks. As an example, and not by way of limitation, communication interface may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface. As an example, and not by way of limitation, the computing system may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computing system may communicate with a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination of two or more of these. The computing system may include any suitable communication interface for any of these networks, where appropriate.

An exemplary embodiment of the present invention may include the following elements:
Main PCB/Single Board Computer/Circuit Board located in the rear of tablet connects parts and components to operate devices
Daughter Board, located on Main PCB/Single Board computer/Circuit Board EMI Shield, Logic Board found in rear of tablets protecting main board secured with glue or adhesive or screws sizes 2.5 mm, 3.5 mm, 3 mm, 4 mm, 4.1 mm, 1.2 mm.
Processor, CoProcessor
Two Full size 7 inch-10.7 inches of Touchscreens Displays Front and Back of each Device
LCD Panel
Digitizer
Parallel Interface
Left and Right antennas/carriers,
Microphone printed circuit board (PCB) located in each device,
Home Button
Headphone Socket 3.5 mm located on the top right of the devices
Loudspeaker Assembly/Carrier Left/Right located on inside on the bottom of each device on the left and right
Power Flex Volume
Speaker left and right located on top left and right of Antennas
Primary Rear facing Camera Secondary Front Facing Camera located in the top middle of devices connected to main board
Rear Camera lens located on the back of each device up above back touchscreen display
Communications interface
3G Module, I/O Connector
Sim Card PCB, Sim Card
Wifi, Bluetooth, Wlan, GPS antenna
Display InterConnect
Power Management Sensor
battery/battery pack lithium located in the rear of each device connected to the single board computer
Charge Port Flex located inside of devices connected to SBC, USB2, USB3 located on right bottom side view of devices. USB Charging Dock located on Bottom middle
Wireless Transmitter Coil, Inductive Charging Coil
Audio Interface PCB, Audio Jack PCB
Temperature/Humidity Sensor
Barometer
Clock Generator
Audio Codec
Battery Charger
Accelerometer
Gyroscope
Wireless Chips
LTE
Touchscreen Controllers
Camera Flash PCB
Speaker AMP
Flash EMMD
Camera Core
VCC RAM
LED Flashing Alert Sensor
FR Transceiver
Camera AVDD
HDMI VDD
Nand 16 GB
Microphone Element
Transmit Module
Embedded Controller
Regulator
LNA-WCDMA
Keyboard Controller
Touchscreen IC
Flash Nor 8 Mb SPI Interface
Filter inducter
Filter Capacitor
USB Protocol Resistors
Speaker IC
NFC Antenna
Output Diode
Connector Dock
Platform Controller Hub
CPU, 1.1 GHZ 400 MZ Cache
PCB Antenna
USB Switch
Image Sensor
Power Management IC
RF Module
Baseband
I/O Connector
WIFI VCC
Multimedia Application Processor
USB 2.0 Card Reader Controller
Video Encoder
Wire Harness
DCDC Controller
Internal Antenna
Ethernet Controller
Demodulator
Electronic Compass
GPS Receiver
Step-Up/Step-Down Converter
Antenna Switch Module
VGA Video Interface
Camera REF
Voice Processor
Crystals
RF Tuner
SD RAM MOBILE DDRS
BLUETOOTH™
Wifi
GPS
Flash
Nand and Ram
Keyboard Controller
Memory
Expandable Storage Sim Card and Tray
Sim Card Connector
Audio Jack PCB
Ambient Light Sensor
Operating system
HD Video/Playback 1080p
Network Connectivity
GPS Antenna
Wifi Antenna
Interconnect PCB
Usb2 Port2, Usb3 Port3 Lower right side of device
LED PCB
Speakers
Sensors
NFC Controller
Main Clock
Backlight
LCD Power
3G Module
SD RAM MOBILE DDR3
Dual Apps Processor
Optical Proximity Sensor
Digital Compass
Motherboard Top and Bottom
Bi Directional High side Power Switch
USB-OTG Combined Application
Dual supply Translating Transceiver
Multiplexer/Demultiplexer switch
mating connectors
mounting screws
external flash cards
MCP
Magnetomer
Battery Charger
memory card reader
automation sensors
SD Ram LPDDR3
Cell Antenna
Controller
main PCB top and bottom
2×4-lane MIPI DSI
2×4 lane MIPI CSI
WLAN PCB connecting to SBC
Power Flex/Volume l& 2
Volume buttons located on the right side top of devices
Wireless Charging Transmitter/Inductive charging Coil
Lightning port
Display Module 7 in-10.7 inches Capacitive Touchscreen directly on back of each device
Bottom closure Digitizer/Touchscreen Assembly fused with Brackets, adhesive, conductive adhesive, glue, tape (insulating), pull tabs, ZIF connectors, screws foam tape, cable connectors, digital cable connectors, ribbon cable connectors, connector latches, display cable connectors, flexible cable connector, fit connector, auxiliary port, electrical connector, wire strips—connectors, Chassis, USB port shield

A method of using the present invention may include the following. Press the power on button 40 at the top of tablet 10. Use the home button on the bottom front or back to get to applications and press and play. For Alzheimer's Dementia Patients the present invention may include an Automatic Alarm Settings, an Automatic alarm power on and off, an Automatic alarm slideshow format, an Automatic wireless charge. The present invention includes an easy mode for dementia patients designed for stimulation and mobility of viewing on both sides using sight method, same mode, different mode, a digital single frame slideshow format, fun shapes, favorite colors, twin screens front and back, built in apps, hot spot, GPS Location, and three USB Ports.

It should be understood, of course, that the foregoing relates to exemplary embodiments of the invention and that modifications may be made without departing from the spirit and scope of the invention as set forth in the following claims.

What is claimed is:

1. An electronic tablet comprising:
a housing comprising a front surface having a front periphery and a rear surface having a rear periphery, wherein the front periphery is an outline of a design, and the rear periphery is an outline of a mirror image of the design; and
a computing system coupled to and disposed within the housing, the computing system comprising:
a processor;
a memory;
a communications interface; and
a user interface comprising at least a first touch screen interface disposed on the front surface, and a second touch screen interface disposed on the rear surface.

2. The electronic tablet of claim 1, wherein the first touch screen interface and the second touchscreen interface are disposed along parallel planes.

3. The electronic tablet of claim 1, wherein the design is an outer shape of an animal.

4. The electronic tablet of claim 1, wherein the design is an outer shape of one of a basketball, a soccer ball, a football, a baseball, a cat, a dog, a fish, a purse, a cube, a ladybug, a school bus, a briefcase, and a lunchbox.
